(19) United States
(12) Patent Application Publication
(10) Pub. No.: US 2012/0185618 A1
(43) Pub. Date: Jul. 19, 2012

(54) METHOD FOR PROVIDING SCALABLE STORAGE VIRTUALIZATION

(75) Inventor: Hamid Assarpour, Arlington, MA (US)

(73) Assignee: Avaya Inc., Basking Ridge, NJ (US)

(21) Appl. No.: 13/077,610

(22) Filed: Mar. 31, 2011

Related U.S. Application Data
(60) Provisional application No. 61/432,267, filed on Jan. 13, 2011.

(51) Int. Cl. G06F 13/10

(52) U.S. Cl. 710/15

(57) ABSTRACT

A method, apparatus and computer program product for providing scalable storage virtualization is presented. Storage virtualization management functions are provided in a first device, and storage virtualization Input/Output (I/O) functions are provided in a second device. An interface is provided between the first device and the second device, wherein the first device manages and updates I/O functions of the second device. I/O operations are performed between the second device and at least one storage device.

### CROSS REFERENCE TO RELATED APPLICATIONS

The present application claims the benefit of U.S. Provisional Patent Application No. 61/432,267, filed on Jan. 13, 2011, which is incorporated herein by reference in its entirety.

### BACKGROUND

Storage virtualization is the pooling of physical storage from multiple network storage devices into what appears to be a single logical entity that is managed from a central console. Storage virtualization adds an abstraction layer between the physical storage devices and the hosts using those devices. This abstraction layer becomes the traffic cop for storage, redirecting read and write requests to appropriate locations without the administrator having to worry about the specifics. With a fully implemented storage virtualization platform, administrators create virtual disks that the storage abstraction layer then maps to physical devices. Storage virtualization also allows the administrator to combine storage from different vendors into a single, logical pool.

Currently, the storage virtualization solutions are implemented mainly in one of three forms. One form of storage virtualization is known as server based. Server based storage virtualization requires additional software running on the server, as a privileged task or process. In some cases volume management is built-in to the operating system, and in other instances it is offered as a separate product. Volumes presented to the server system are handled by a traditional physical device driver. However, a software layer (the volume manager) resides above the disk device driver, intercepts the Input/Output (I/O) requests, and provides the meta-data lookup and I/O mapping. Advantages associated with server based storage virtualization include no additional hardware or infrastructure requirements, they are simple to design and code, they support any storage type, and they improve storage utilization without thin provisioning restrictions.

Another form of storage virtualization is known as storage controller based. A primary storage controller provides the virtualization services and allows the direct attachment of other storage controllers. Depending on the implementation these may be from the same or different vendors. The primary controller provides the pooling and meta-data management services. The primary controller may also provide replication and migration services across those controllers which it is virtualizing. Advantages associated with controller based storage virtualization include no additional hardware or infrastructure requirements, provides most of the benefits of storage virtualization, and does not add latency to individual I/Os.

Another form of storage virtualization is known as network based. Storage virtualization operating on a network based device (typically a standard server or smart switch) and using Small Computer System Interconnect (iSCSI) or Fibre Channel (FC) networks to connect as a Storage Area Network (SAN). These types of devices are the most commonly available and implemented form of virtualization. The virtualization device sits in the SAN and provides the layer of abstraction between the hosts performing the I/O and the storage controllers providing the storage capacity. Advantages associated with network based storage virtualization include true heterogeneous storage virtualization, caching of data (performance benefit) is possible when in-band, single management interface for all virtualized storage, and replication services across heterogeneous devices.

### SUMMARY

Storage virtualization functions include two main functions: virtualization management functions and I/O functions. All of the current solutions (server based, storage controller based, and network-based) integrate both of these functions into a single monolithic software/hardware platform without any physical or logical separation between the two. Conventional mechanisms for performing storage virtualization such as those explained above suffer from a variety of deficiencies. This conventional approach limits scalability and I/O bandwidth performance on server-based and storage-based solutions, and complicates design on network-based solutions.

Deficiencies associated with server based storage virtualization include utilization optimized only on a per host basis, replication and data migration only possible locally to that host, the software is unique to each operating system, and there is no easy way of keeping host instances in sync with other instances.

Deficiencies associated with controller based storage virtualization include utilization optimized only across the connected controllers, replication and data migration only possible across the connected controllers and same vendors device for long distance support, downstream controller attachment limited to vendors support matrix and I/O latency, non cache hits require the primary storage controller to issue a secondary downstream I/O request.

Deficiencies associated with network based storage virtualization include complex interoperability matrices—limited by vendors support, difficult to implement fast meta-data updates in switched-based devices, out-of-band requires specific host based software, in-band may add latency to I/O, and in-band is the most complicated to design and code

Embodiments of the invention significantly overcome such deficiencies and provide mechanisms and techniques that provide scalable storage virtualization. In a particular embodiment of a method for providing scalable storage virtualization the method includes providing storage virtualization management functions in at least one first device, and providing storage virtualization Input/Output (I/O) functions in at least one second device. The method further includes providing an interface between the first devices and the second devices, wherein the first device manages and updates I/O functions of the second device. The second device performs I/O operations with at least one storage device.

Other embodiments include a computer readable medium having computer readable code thereon for providing scalable storage virtualization. The computer readable medium includes instructions for storage virtualization management functions in at least one first device, and instructions for providing storage virtualization Input/Output (I/O) functions in at least one second device. The computer readable medium further includes instructions for providing an interface between the first device and the second device, wherein the first device manages and updates I/O functions of the second device, and the second device performs I/O operations with at least one storage device.

Still other embodiments include computerized devices, configured to process all the method operations disclosed herein as embodiments of the invention. In such embodiments, the computerized devices include a memory system, a processor, communications interface in an interconnection mechanism connecting these components. The memory system is encoded with a process that provides scalable storage virtualization as explained herein that when performed (e.g. when executing) on the processor, operates as explained herein within the computerized devices to perform all of the method embodiments and operations explained herein as embodiments of the invention. Thus any computerized devices that perform or are programmed to perform the processing explained herein are embodiments of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing scalable storage virtualization as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Avaya, Inc. of Basking Ridge, N.J.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 depicts a block diagram of a prior art storage virtualization system;

FIG. 2 depicts a block diagram of a storage virtualization system that performs scalable storage virtualization in accordance with embodiments of the invention;

FIG. 3 depicts a flow diagram of a particular embodiment of a method for performing scalable storage virtualization in accordance with embodiments of the invention;

FIG. 4 illustrates an example architecture for a storage virtualization management device that performs scalable storage virtualization in accordance with embodiments of the invention; and

FIG. 5 illustrates an example architecture for a storage virtualization I/O device that performs scalable storage virtualization in accordance with embodiments of the invention.

### DETAILED DESCRIPTION

The presently described method and apparatus providing scalable storage virtualization splits the storage virtualization management functions and I/O functions into two separate logical and physical entities with very well defined interface between the two such that virtualization management functions can be integrated into one or more separate standalone devices, and I/O functions can be distributed across one or more network switching devices/platforms.

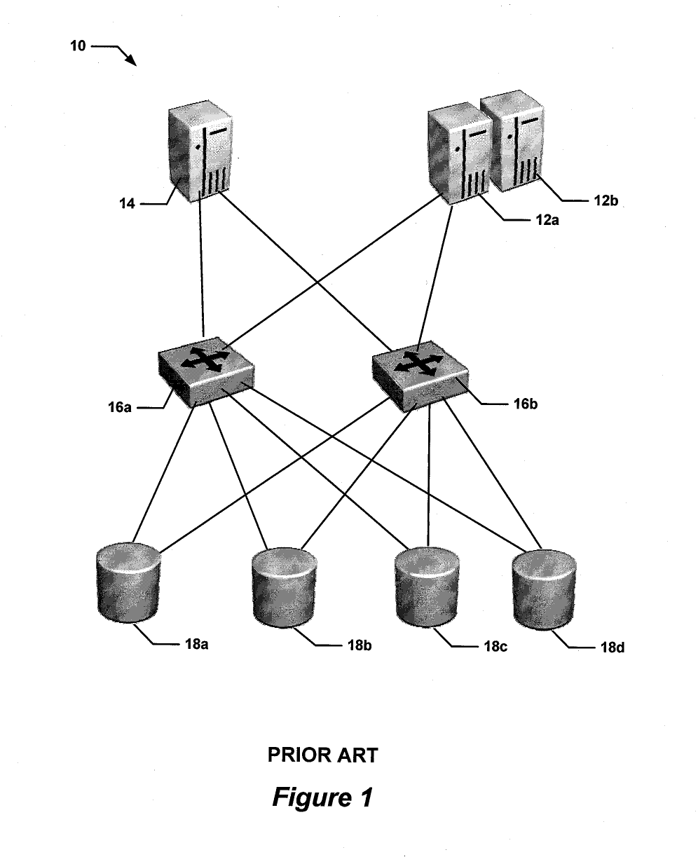

Referring now to FIG. 1, a prior art storage virtualization system 10 is shown. Storage virtualization system 10 includes a plurality of initiators 12a and 12b, a storage virtualization appliance 14, two network switches 16a, and 16b, and target devices 18a-18d. The initiators 12a and 12b are in communication with each network device 16a and 16, as is storage virtualization device 14. Network devices 16a and 16b are each in communication with each target (storage device) 18a-18d. In operation, a request (e.g., a read request or a write request) is initiated by one of the initiators 12a or 12b and forwarded to a network device 16a or 16b. The request is then forwarded to storage virtualization device 14. Here the I/O redirection is performed wherein the logical disk location contained in the request is translated into a physical disk location and the request, now containing the physical disk location, is forwarded via a network device 16a or 16b to the appropriate target, one of devices 18a-18d. As can be seen from the above example, the prior art methodology provides limited scalability and an eventual bottleneck due to the centralized architecture.

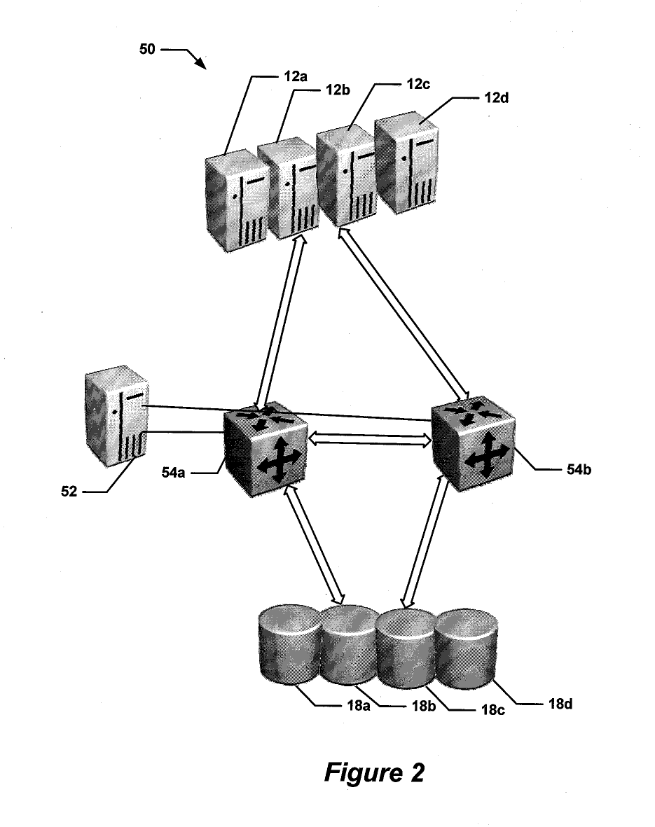

The arrangement shown in FIG. 1 and also in FIG. 2, is particularly suitable when the Advanced Technology Attachment (ATA) over Ethernet (AoE) network protocol is used. AoE provides simple, high-performance access of SATA (serial ATA) storage devices over Ethernet networks. AoE is used to build storage area networks (SANs) with low-cost, standard technologies. AoE runs on layer 2 Ethernet. AoE does not use Internet Protocol (IP) and it cannot be accessed over the Internet or other IP networks. In this regard it is more comparable to Fibre Channel over Ethernet than iSCSI. This approach makes AoE more lightweight (with less load on the host), makes it easier to implement, provides a layer of inherent security, and offers higher performance. ATA encapsulation SATA (and older Parallel ATA) hard drives use the ATA protocol to issue commands, such as read, write, and status. AoE encapsulates those commands inside Ethernet frames and lets them travel over an Ethernet network instead of a SATA or 40-pin ribbon cable. By using an AoE driver, the host operating system is able to access a remote disk as if it were directly attached. The encapsulation of ATA provided by AoE is simple and low-level, allowing the translation to happen either at high performance or inside a small, embedded device, or both.

Referring now to FIG. 2, a scalable storage virtualization environment 50 which utilizes a split-plane in-band storage virtualization architecture is shown. Environment 50 includes a plurality of initiators 12a-12d, similar to initiators 12a-12d shown in FIG. 1. Initiators 12a-12d are in communication with storage virtualization I/O devices 54a and 54b. Also in communication with storage virtualization I/O devices 54a and 54b is storage virtualization manager 52. Storage virtualization I/O devices 54a and 54b are each in communication with each target (storage device) 18a-18d.

The storage virtualization management device 52 manages I/O redirection, maintains and synchronizes the I/O meta-data tables, and performs other functions I/O related. The I/O meta-data tables are used to perform the mapping between the logical addresses and physical addresses. When a storage packet comes in, inside the packet itself is a logical block address and a logical unit number. These numbers are used to access an I/O meta-data table entry and get mapped to physical block and physical unit number. The I/O redirection process running on the storage virtualization management devices snoops the packet for this data. These I/O meta-data tables are maintained by the storage virtualization management system(s) 52. The storage virtualization I/O function devices 54a and 54b perform I/O operations with the storage devices 18a-18d. In this example a single storage virtualization management device 52 is shown, although it should be appreciated that any number can be used, also two storage virtualization I/O devices 54a and 54b are shown, although it should be appreciated that any number can be used.

Scalability is provided as any number of storage virtualization management devices 52 can be used with any number of storage virtualization I/O function devices 54. The storage virtualization management devices communicate directly with the storage virtualization I/O function devices by way of a dedicated interface on each of the devices. The communication can be by way of a specific protocol. The ability to use separate storage virtualization management devices and separate storage virtualization I/O function devices provides increased performance and resiliency, especially in an environment where storage and virtual machines are predominate, for example in a data center. Further, a data center can use one vendor for storage virtualization management systems and another vendor for storage virtualization I/O systems, thereby providing a multi-vendor solution.

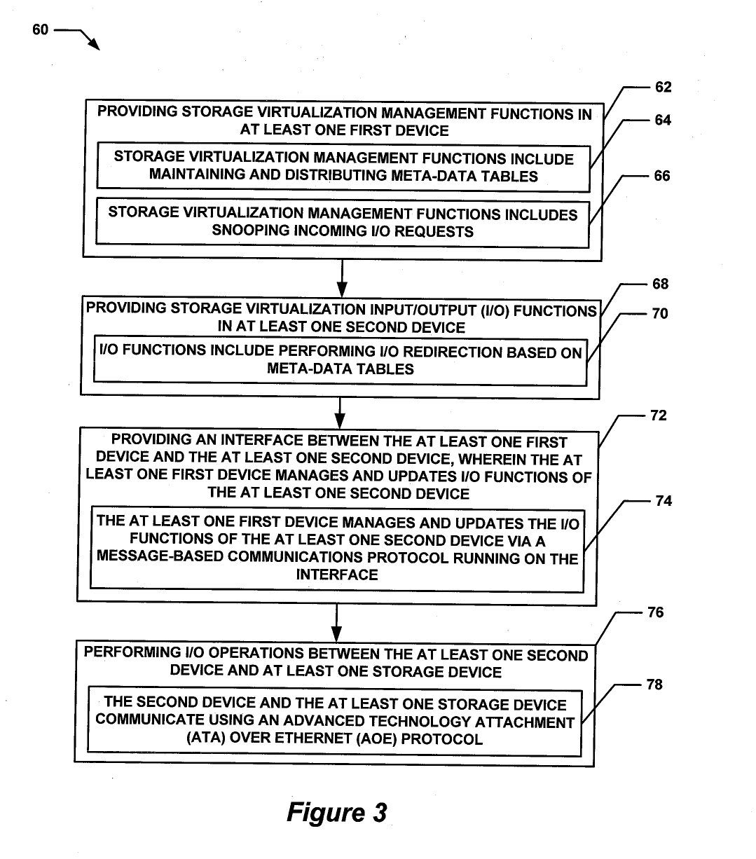

A flow chart of a particular embodiment of the presently disclosed method is depicted in FIG. 3. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 3, a flow diagram of a particular embodiment of a method 100 for providing scalable storage virtualization is shown. Method 100 begins with processing block 102 which discloses providing storage virtualization management functions in at least one first device. The first device comprises a storage virtualization management device. As shown in processing block 104 storage virtualization management functions include maintaining and distributing metadata tables. The meta-data tables are used for performing I/O redirection as part of the storage virtualization processing. As further shown in processing block 106, storage virtualization management functions include snooping incoming I/O requests.

Processing block 108 states providing storage virtualization Input/Output (I/O) functions in at least one second device. The second device comprises a storage virtualization I/O device. As shown in processing block 110, the I/O functions include performing I/O redirection based on metadata tables. As an example, the storage virtualization I/O device may receive a read request for logical disk Logical Unit Number (LUN) ID=1, Logical Block Address (LBA)=32. This is a request for access to a logical disk. By way of the meta-data table, this request will be retranslated into a request for a physical disk location. A meta-data table lookup is performed by the storage virtualization I/O device for LUN ID=1, LBA=32 and, in this example, is mapped to physical LUN ID=7, LBA=0. The read request will then be sent to physical LUN ID=7, LBA=0, and the storage virtualization I/O device will receive back the data from the physical disk. This data will then be sent to the originator as if it had come from logical address LUN ID=1, LBA=32.

Processing block recites providing an interface between the at least one first device and the at least one second device, wherein the at least one first device manages and updates I/O functions of the at least one second device. This is done via a separate dedicated communication bus, and permits the messaging between the virtualization controller and the switch control plane to take place. As shown in processing block 114, the at least one first device manages and updates the I/O functions of the at least one second device via a message-based communications protocol running on the interface.

Processing block 116 discloses performing I/O operations between the at least one second device and at least one storage device. Reads and writes take place between the storage virtualization I/O device and the storage devices. As shown in processing block 118, the second device and the at least one storage device communicate using an Advanced Technology Attachment (ATA) over Ethernet (AoE) protocol.

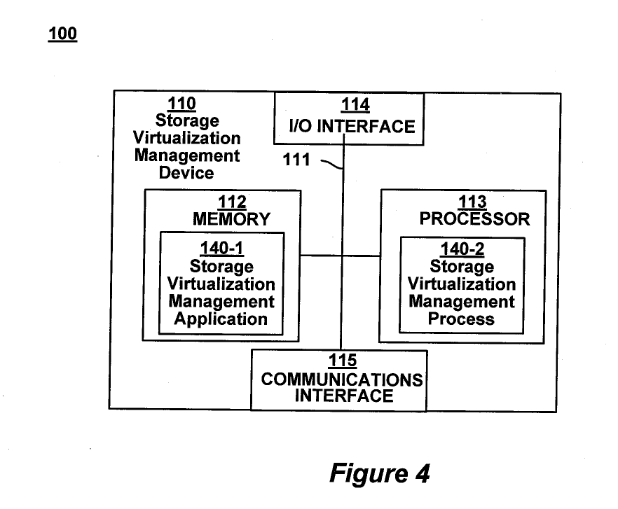

Referring now to FIG. 4, a block diagram illustrating an example architecture of a computer system (storage virtualization manager) 110 that executes, runs, interprets, operates or otherwise performs a storage virtualization management application 140-1 and storage virtualization management process 140-2 suitable for use in explaining example configurations disclosed herein. The computer system 110 may be any type of computerized device such as a personal computer, workstation, portable computing device, console, laptop, network terminal or the like. As shown in this example, the computer system 110 includes an interconnection mechanism 111 such as a data bus or other circuitry that couples a memory system 112, a processor 113, an input/output interface 114, and a communications interface 115. The communications interface 115 enables the computer system 110 to communicate with other devices (i.e., other computers) on a network (not shown).

The memory system 112 is any type of computer readable medium, and in this example, is encoded with a storage virtualization management application 140-1 as explained herein. The storage virtualization management application 140-1 may be embodied as software code such as data and/or logic instructions (e.g., code stored in the memory or on another computer readable medium such as a removable disk) that supports processing functionality according to different embodiments described herein. During operation of the computer system 110, the processor 113 accesses the memory system 112 via the interconnect 111 in order to launch, run, execute, interpret or otherwise perform the logic instructions of a storage virtualization management application 140-1. Execution of a storage virtualization management application 140-1 in this manner produces processing functionality in the storage virtualization management process 140-2. In other words, the storage virtualization management process 140-2 represents one or more portions or runtime instances of a storage virtualization management application 140-1 (or the entire a storage virtualization management application 140-1) performing or executing within or upon the processor 113 in the computerized device 110 at runtime.

It is noted that example configurations disclosed herein include the storage virtualization management application 140-1 itself (i.e., in the form of un-executed or non-performing logic instructions and/or data). The storage virtualization management application 140-1 may be stored on a computer readable medium (such as a floppy disk), hard disk, electronic, magnetic, optical, or other computer readable medium. A storage virtualization management application 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of a storage virtualization management application 140-1 in the processor 113 as the storage virtualization management process 140-2. Those skilled in the art will understand that the computer system 110 may include other processes and/or software and hardware components, such as an operating system not shown in this example.

During operation, processor 113 of computer system 100 accesses memory system 112 via the interconnect 111 in order to launch, run, execute, interpret or otherwise perform the logic instructions of the storage virtualization management 140-1. Execution storage virtualization management application 140-1 produces processing functionality in storage virtualization management process 140-2. In other words, the storage virtualization management process 140-2 represents one or more portions of the storage virtualization management application 140-1 (or the entire application) performing within or upon the processor 113 in the computer system 100.

It should be noted that, in addition to the storage virtualization management process 140-2, embodiments herein include the storage virtualization management application 140-1 itself (i.e., the un-executed or non-performing logic instructions and/or data). The storage virtualization management application 140-1 can be stored on a computer readable medium such as a floppy disk, hard disk, or optical medium. The storage virtualization management application 140-1 can also be stored in a memory type system such as in firmware, read only memory (ROM), or, as in this example, as executable code within the memory system 112 (e.g., within Random Access Memory or RAM).

In addition to these embodiments, it should also be noted that other embodiments herein include the execution of storage virtualization management application 140-1 in processor 113 as the storage virtualization management process 140-2. Those skilled in the art will understand that the computer system 100 can include other processes and/or software and hardware components, such as an operating system that controls allocation and use of hardware resources associated with the computer system 100.

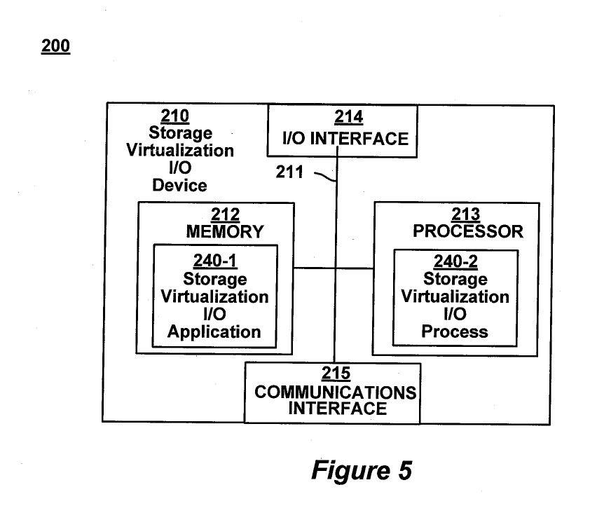

Referring now to FIG. 5, a block diagram illustrating an example architecture of a computer system (storage virtualization I/O device) 210 that executes, runs, interprets, operates or otherwise performs a storage virtualization I/O application 240-1 and storage virtualization I/O process 240-2 suitable for use in explaining example configurations disclosed herein. The computer system 210 may be any type of computerized device such as a personal computer, workstation, portable computing device, console, laptop, network terminal or the like. As shown in this example, the computer system 210 includes an interconnection mechanism 211 such as a data bus or other circuitry that couples a memory system 212, a processor 213, an input/output interface 214, and a communications interface 215. The communications interface 215 enables the computer system 210 to communicate with other devices (i.e., other computers) on a network (not shown).

The memory system 212 is any type of computer readable medium, and in this example, is encoded with a storage virtualization I/O application 240-1 as explained herein. The storage virtualization I/O application 240-1 may be embodied as software code such as data and/or logic instructions (e.g., code stored in the memory or on another computer readable medium such as a removable disk) that supports processing functionality according to different embodiments described herein. During operation of the computer system 210, the processor 213 accesses the memory system 212 via the interconnect 211 in order to launch, run, execute, interpret or otherwise perform the logic instructions of a storage virtualization I/O application 240-1. Execution of a storage virtualization I/O application 240-1 in this manner produces processing functionality in the storage virtualization I/O process 240-2. In other words, the storage virtualization I/O process 240-2 represents one or more portions or runtime instances of a storage virtualization I/O application 240-1 (or the entire a storage virtualization I/O application 240-1) performing or executing within or upon the processor 213 in the computerized device 210 at runtime.

It is noted that example configurations disclosed herein include the storage virtualization I/O application 240-1 itself (i.e., in the form of un-executed or non-performing logic instructions and/or data). The storage virtualization I/O application 240-1 may be stored on a computer readable medium (such as a floppy disk), hard disk, electronic, magnetic, optical, or other computer readable medium. A storage virtualization I/O application 240-1 may also be stored in a memory system 212 such as in firmware, read only memory (ROM), or, as in this example, as executable code in, for example, Random Access Memory (RAM). In addition to these embodiments, it should also be noted that other embodiments herein include the execution of a storage virtualization I/O application 240-1 in the processor 213 as the storage virtualization I/O process 240-2. Those skilled in the art will understand that the computer system 210 may include other processes and/or software and hardware components, such as an operating system not shown in this example.

During operation, processor 213 of computer system 200 accesses memory system 212 via the interconnect 211 in order to launch, run, execute, interpret or otherwise perform the logic instructions of the storage virtualization I/O application 240-1. Execution of storage virtualization I/O application 240-1 produces processing functionality in storage virtualization I/O process 240-2. In other words, the storage virtualization I/O process 240-2 represents one or more portions of the storage virtualization I/O application 240-1 (or the entire application) performing within or upon the processor 213 in the computer system 200.

It should be noted that, in addition to the storage virtualization I/O process 240-2, embodiments herein include the storage virtualization I/O application 240-1 itself (i.e., the un-executed or non-performing logic instructions and/or data). The storage virtualization I/O application 240-1 can be stored on a computer readable medium such as a floppy disk, hard disk, or optical medium. The storage virtualization I/O application 240-1 can also be stored in a memory type system such as in firmware, read only memory (ROM), or, as in this example, as executable code within the memory system 212 (e.g., within Random Access Memory or RAM).

In addition to these embodiments, it should also be noted that other embodiments herein include the execution of storage virtualization I/O application 240-1 in processor 213 as the storage virtualization I/O process 240-2. Those skilled in the art will understand that the computer system 200 can include other processes and/or software and hardware components, such as an operating system that controls allocation and use of hardware resources associated with the computer system 200.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the Internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Additionally, the software included as part of the invention may be embodied in a computer program product that includes a computer usable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

1. A computer-implemented method in which a computer system performs operations providing scalable storage virtualization comprising:
providing storage virtualization management functions in at least one first device;
providing storage virtualization Input/Output (I/O) functions in at least one second device;
providing an interface between said at least one first device and said at least one second device, wherein said at least one first device manages and updates I/O functions of said at least one second device; and
performing I/O operations between said at least one second device and at least one storage device.

2. The computer-implemented method of claim 1 wherein storage virtualization management functions include maintaining and distributing metadata tables.

3. (canceled)

4. The computer-implemented method of claim 1 wherein said I/O functions include performing I/O redirection based on metadata tables.

5. The computer-implemented method of claim 1 wherein said second device and said at least one storage device communicate using an Advanced Technology Attachment (ATA) over Ethernet (AoE) protocol.

6. The computer-implemented method of claim 1 wherein said at least one first device manages and updates said I/O functions of said at least one second device via a message-based communications protocol running on said interface.

7. A non-transitory computer readable storage medium having computer readable code thereon for providing scalable storage virtualization, the medium including instructions in which a computer system performs operations comprising:
providing storage virtualization management functions in at least one first device;
providing storage virtualization Input/Output (I/O) functions in at least one second device;
providing an interface between said at least one first device and said at least one second device, wherein said at least one first device manages and updates I/O functions of said at least one second device; and
performing I/O operations between said at least one second device and at least one storage device.

8. The non-transitory computer readable storage medium of claim 7 wherein storage virtualization management functions include maintaining and distributing metadata tables.

9. (canceled)

10. The non-transitory computer readable storage medium of claim 7 wherein said I/O functions include performing I/O redirection based on metadata tables.

11. The non-transitory computer readable storage medium of claim 7 wherein said second device and said at least one storage device communicate using an Advanced Technology Attachment (ATA) over Ethernet (AoE) protocol.

12. The non-transitory computer readable storage medium of claim 7 wherein said at least one first device manages and updates said I/O functions of said at least one second device via a message-based communications protocol running on said interface.

13. A storage virtualization management device comprising:
a memory;
a processor;
a communications interface;
an interconnection mechanism coupling the memory, the processor and the communications interface; and
wherein the memory is encoded with an application providing storage virtualization, that when performed on the processor, provides a process for processing information, the process causing the storage virtualization management device to perform the operations of:
providing storage virtualization management functions; and
transmitting at least some of said storage virtualization management functions via said communications interface to at least one storage virtualization Input/Output (I/O) device.

14. The storage virtualization management device of claim 13 wherein said storage virtualization management functions include maintaining metadata tables.

15. The storage virtualization management device of claim 13 wherein said storage virtualization management functions include snooping incoming I/O requests.

16. The storage virtualization management device of claim 13 wherein said storage virtualization management functions includes managing and updating said I/O functions of said at least one second device via a message-based communications protocol running on said interface.

17. The storage virtualization management device of claim 13 wherein said storage virtualization management device manages and updates said I/O functions of said at least one second device via a message-based communications protocol running on said interface.

18. A storage virtualization Input/Output (I/O) device comprising:
a memory;
a processor;
a communications interface;
an interconnection mechanism coupling the memory, the processor and the communications interface; and
wherein the memory is encoded with an application providing storage virtualization, that when performed on the processor, provides a process for processing information, the process causing the storage virtualization I/O device to perform the operations of:
providing storage virtualization I/O functions;
receiving storage virtualization management functions via said communications interface from at least one storage virtualization management device; and
performing I/O operations with at least one storage device.

19. The storage virtualization I/O device of claim 18 wherein said I/O functions include performing I/O redirection based on metadata tables.

20. The storage virtualization I/O device of claim 19 wherein said storage virtualization I/O device and at least one storage device communicate using an Advanced Technology Attachment (ATA) over Ethernet (AoE) protocol.

21. The method of claim 1 wherein at least two of said first devices are used with any number of second devices to provide increased performance and resiliency or wherein any number of said first devices are used with at least two second devices to provide increased performance and resiliency.

22. The non-transitory computer readable storage medium of claim 7 further comprising instructions wherein at least two of said first devices are used with any number of second devices to provide increased performance and resiliency or wherein any number of said first devices are used with at least two second devices to provide increased performance and resiliency.
